(19) United States
(12) Patent Application Publication
(10) Pub. No.: US 2012/0251800 A1
(43) Pub. Date: Oct. 4, 2012

(54) TOUCH PANEL GLASS SUBSTRATE AND METHOD FOR MANUFACTURING SAME

(75) Inventors: Naomi NAKAYAMA, Toyama (JP); Tsutomu INOUE, Toyama (JP); Toshiyuki MAEHARA, Toyama (JP)

(73) Assignee: SMK CORPORATION, Tokyo (JP)

(21) Appl. No.: 13/404,011

(22) Filed: Feb. 24, 2012

(30) Foreign Application Priority Data
Mar. 28, 2011 (JP) 2011-070266

(51) Int. Cl. C03C 17/00; B32B 3/10; C03C 15/00

(52) U.S. Cl. 428/210; 65/31

(57) ABSTRACT

A touch panel glass substrate which can be manufactured simultaneously with other touch panel glass substrates, is free of microcracks in edges, and has predetermined strength, and a method for manufacturing the same are provided. An original glass plate as large as to cut out a plurality of glass substrates is prepared. Detection electrode traces and lead wiring traces on each glass substrate are simultaneously formed on the original glass plate. The original glass plate is then chemically etched to separate the touch panel glass substrates. The separation by chemical etching produces no microcracks in edges.

### CROSS REFERENCE TO RELATED APPLICATION

The contents of the following Japanese patent application are incorporated herein by reference,
NO. 2011-070266 filed on Mar. 28, 2011.

### BACKGROUND

1. Technical Field

The present invention relates to a touch panel glass substrate on the surface of which a transparent detection electrode pattern for detecting an input position and a wiring pattern for connecting the detection electrode pattern to outside are formed, and a method for manufacturing the same. More particularly, the present invention relates to a touch panel glass substrate which is free of microcracks and has excellent strength even with a small thickness, and a method for manufacturing the same.

2. Description of the Related Art

Touch panels are mounted as an instruction input device on various types of apparatuses including cellular phones, automotive navigation systems, and portable information terminals. A touch panel is typically combined with a display unit that is stacked and arranged inside, and is used to detect the input position of an input operation member, such as a finger, aimed at a display on the display unit.

Various methods for detecting an input position have been proposed by which a touch panel detects the input position of an input operation member. Examples include a resistive pressure-sensitive method of detecting an input position from resistances between the input position and reference electrodes, a capacitive method of detecting an input position from a change in stray capacitance at the input position due to the approach of the input operation member, and an electromagnetic induction method of detecting an input position from the position of an electrode that receives an electric signal from the input operation member in the form of electromagnetic induction. Any of such detection methods for detecting an input position from an electrical change include forming one or a plurality of conductive detection patterns on a surface of an insulating substrate which serves as an input operation surface.

The foregoing touch panel with a display unit arranged inside is composed of transparent components so that the display on the display unit inside is visible through the input operation surface of the touch panel. The touch panel uses a touch panel glass substrate, which includes a transparent glass substrate as an insulating substrate and on the surface of which a detection electrode pattern made of ITO or other transparent conductive material is formed.

The detection electrode pattern made of a transparent conductive material is patterned on the surface of the glass substrate by photolithography. A wiring pattern for connecting the detection electrode pattern to an external circuit is also formed on the surface of the glass substrate, in connection with the detection electrode pattern. The formation of the detection electrode pattern and wiring pattern on the surface of the glass substrate needs a number of steps including the formation of a transparent conductive film by sputtering, the application of a photoresist layer, the exposure and development of the photoresist layer, the etching of the transparent conductive film, and the printing of the wiring pattern. In the conventional manufacturing of a touch panel glass substrate, the foregoing steps are applied to the surface of an original glass plate as large as to cut out a plurality of glass substrates, whereby the detection electrode patterns and wiring patterns of the respective glass substrates are simultaneously formed. Each individual glass substrate is then cut out of the original glass plate (Japanese Patent No. 4000178 (paragraphs 0035 to 0036 of the specification and FIG. 5)).

The step of cutting the glass substrates out of the original glass plate is performed by so-called scribing and cutting. Specifically, the original glass plate is cut in by a diamond cutter or the like along the outlines of the respective glass substrates, and pressed by a press machine from both sides of the cuts (Japanese Patent Application Publication No. 2009-294771 (paragraph 0015 of the specification and FIG. 2)).

A capacitive touch panel detects an input position from a change in capacitance on a detection electrode pattern due to the approach of an input operation member such as a finger. The formation of such a capacitive touch panel includes overlaying a protective film onto a glass substrate on the surface of which the detection electrode pattern has been formed, and a decoration film having a predetermined display print onto around the input operation area.

A touch panel glass substrate manufactured by the conventional manufacturing method is cut out of an original glass substrate by scribing and cutting, and thus has a large number of microcracks in its edges, i.e., cut sections. Since fracture of a glass substrate is often triggered by peripheral microcracks, the scribing and cutting significantly reduces mechanical strength. When a touch panel is used as an input device of a portable electronic apparatus that is desirably low-profile, such as a cellular phone, the glass substrate is also desired to be reduced in thickness, e.g., to 1 mm or less. A thinner original glass plate is prone to splinter in the scribing and cutting process and is thus difficult to handle. The glass substrate is vulnerable to surface impact even after mounted on a portable electronic apparatus, and a transparent protective film or transparent protective substrate needs to be stacked on the surface side. This consequently makes it difficult to reduce the thickness of the entire touch panel. The overlying transparent protective film or transparent protective substrate also impairs transparency.

Chemical strengthening, or ion exchange on the surface of glass, has been known as a means for providing a glass substrate having predetermined strength even with a small thickness of 1 mm or less. A chemically-strengthened original glass plate, however, is not capable of scribing and cutting to cut out glass substrates. Each individual glass substrate needs to be chemically strengthened before the detection electrode pattern and wiring pattern are formed on each glass substrate one by one through a number of steps described above. This significantly deteriorates the manufacturing efficiency.

Another demand for touch panels to be installed on cellular phones is a rounded outline for design reasons. The scribing and cutting with the application of mechanical impact is not capable of cutting along the outline of a curved surface. Curved surfaces have conventionally been formed by cutting and physical polishing, which ends up being expensive. The cutting and polishing can also produce new microcracks, and the problem of deteriorated strength has been left unsolved.

### SUMMARY

The present invention has been achieved in view of the foregoing problems, and it is an object thereof to provide a touch panel glass substrate which can be manufactured simultaneously with other touch panel glass substrates, is free of microcracks in edges, and has predetermined strength, and a method for manufacturing the same.

Another object of the present invention is to provide a touch panel glass substrate that is intended for a touch panel having a curved outline without deterioration in strength, and a method of manufacturing the same.

To achieve the foregoing objects, a method for manufacturing a touch panel glass substrate according to claim 1 of the present invention is a method for manufacturing a touch panel glass substrate that includes a glass substrate on a surface of which a plurality of detection electrode traces made of a transparent conductive layer and a plurality of lead wiring traces electrically connected to the respective detection electrode traces are formed, the method including: a step 1 of virtually assuming cutting lines on both a surface and an underside of an original glass plate as large as to separate a plurality of glass substrates from, and forming a plurality of detection electrode traces made of a transparent conductive layer by patterning in each of glass substrate areas surrounded by the cutting lines on the surface of the original glass plate, the cutting lines being projections of outlines of the plurality of glass substrates on the surface and the underside; a step 2 of forming lead wiring traces in each of the glass substrate areas, the lead wiring traces being electrically connected to the respective detection electrode traces; a step 3 of forming a resist film on both the surface and the underside of the original glass plate on which the plurality of detection electrode traces and lead wiring traces have been formed in the steps 1 and 2, except in cutting areas along the cutting lines; and a step 4 of chemically etching the cutting areas on both the surface and the underside of the original glass plate with the resist film as a mask, thereby separating each glass substrate from the original glass plate.

Since the glass substrates on which a detection electrode pattern and lead lines have been formed are separated from the original glass plate by the chemical etching of the cutting areas, no microcrack occurs in the cut sections.

In a method for manufacturing a touch panel glass substrate according to claim 2, the plurality of detection electrode traces and lead wiring traces are formed in the steps 1 and 2 on each of the glass substrate areas of an original glass plate that has been chemically strengthened.

Even with the chemically-strengthened original glass plate, the glass substrates can be separated by chemical etching without mechanical impact.

In a method for manufacturing a touch panel glass substrate according to claim 3, a color decoration layer is formed on each of the glass substrate areas of the original glass plate before the plurality of detection electrode traces are formed in the step 1.

The color decoration layer is formed on the plurality of glass substrates in one step.

In a method for manufacturing a touch panel glass substrate according to claim 4, the color decoration layer includes an outlined character, and the lead wiring traces are formed to cover the outlined character.

The outlined character is colored with the color of the lead wiring traces.

A touch panel glass substrate according to claim 5 is manufactured by the method for manufacturing according to any of the foregoing claims.

Since the touch panel glass substrate is separated from the original glass plate by chemical etching, no microcrack occurs in the periphery.

In a touch panel glass substrate according to claim 6, the cutting lines include a curve at least in part.

Chemically etching the cutting areas along the partially-curved cutting lines separates glass substrates having a partially-curved outline from the original glass substrate.

According to the inventions of claims 1 and 5, the detection electrode patterns and lead lines on the surfaces of the plurality of glass substrates are simultaneously formed on a single original glass plate. This simplifies the steps for mass-producing a touch panel glass substrate.

Unlike scribing and cutting where mechanical impact is applied to separate glass substrates from an original glass plate, the chemical etching-based separation of the glass substrates causes no microcracks in the separated cut sections. Glass substrates having predetermined strength can be obtained even with a small thickness of 1 mm or less.

Unlike scribing and cutting where mechanical impact is applied to make straight cutting lines, the chemical etching-based separation of the glass substrates can form the cutting lines, i.e., the outlines of the respective glass substrates in arbitrary shapes including curves. The touch panel glass substrate can thus be formed in an arbitrary shape according to design needs.

According to the invention of claim 2, a chemically-strengthened touch panel glass substrate having excellent strength can be produced even if the detection electrode pattern and lead lines are formed on the surface of the glass substrate simultaneously with other glass substrates.

According to the invention of claim 3, it is possible to simultaneously form a color decoration layer on a plurality of glass substrates without printing a color decoration layer on each individual glass substrate or pasting a decoration film one by one.

According to the invention of claim 4, the color of the lead wiring traces can be utilized to color an outlined character in arbitrary color.

According to the invention of claim 6, a touch panel glass substrate can be formed with an arbitrary outline shape. It is therefore possible to form a touch panel in an arbitrary shape according to design needs.

### BRIEF DESCRIPTION OF THE DRAWINGS

FIG. 1 is a plan view of a touch panel glass substrate 1 according to an embodiment of the present invention;

FIG. 2 is a partially-omitted longitudinal sectional view taken along line A-A of FIG. 1;

FIG. 3 is a plan view of an original glass plate 10 with a color decoration layer 6 printed on each glass substrate 1′;

FIG. 4 is a plan view of the original glass plate 10 on which connection conductor pieces 5 are formed;

FIG. 5 is a plan view of the original glass plate 10 before the step of separating touch panel glass substrates 1; and

FIG. 6 is partially-omitted cross-sectional views showing steps of manufacturing a touch panel glass substrate 1, including (a) a step in which the color decoration layer 6 is printed on the original glass plate 10, (b) a step in which a mask made of an exposed and developed photoresist layer 7 is formed on a transparent conductive film 5′, (c) a step in which connection conductor pieces 5 are formed on the original glass plate 10, (d) a step in which intermediate insulation pieces 2 are formed across over the connection conductor pieces 5, (e) a step in which wiring patterns 3 are connected, (f) a step in which areas of the original glass plate 10 corresponding to glass substrates 1′ are masked by light-cured photoresist films 8 both at the surface and the underside, except in cutting areas CA.

### DESCRIPTION OF EXEMPLARY EMBODIMENTS

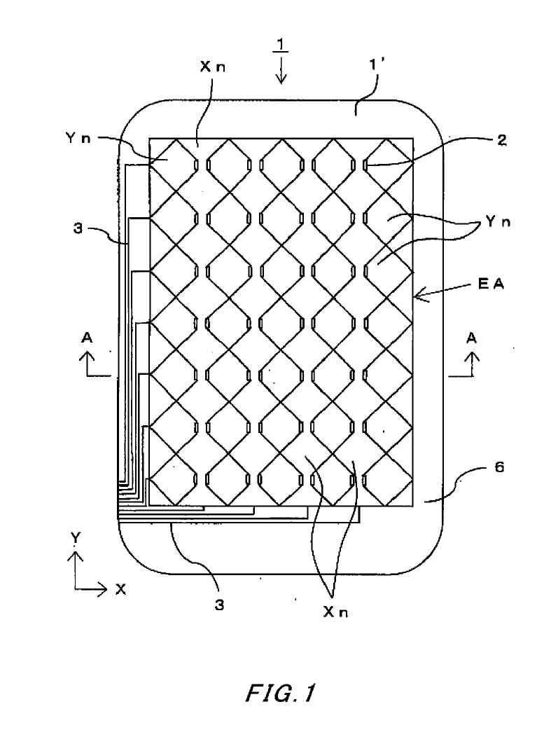

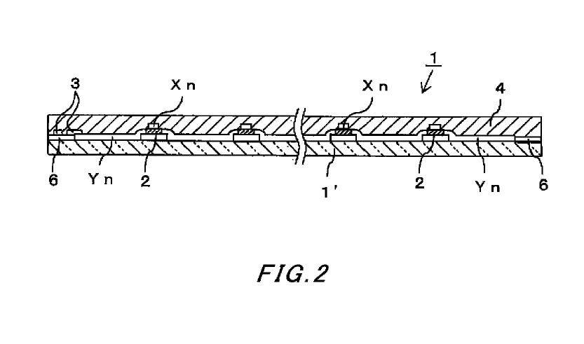

Hereinafter, a touch panel glass substrate 1 and a method for manufacturing the same according to an embodiment of the present invention will be described in detail with reference to FIGS. 1 to 6. A touch panel glass substrate is typically stacked on and arranged in parallel with a display panel such as a liquid crystal panel, and used for a touch panel that detects the input position of an input operation which is aimed at an icon or the like displayed on the display panel. The specific configuration varies depending on the method of detection by which the touch panel detects an input position. The present embodiment deals with a touch panel glass substrate 1 that is intended for a capacitive touch panel which detects an input position from a change in capacitance on a detection electrode pattern due to the approach of an input operation member.

FIG. 1 is a plan view of the touch panel glass substrate 1. In the following description, the glass substrate portion of the touch panel glass substrate 1 will be referred to simply as a glass substrate 1′. The plane of the glass substrate 1′ shown in FIG. 1, on which a detection electrode pattern is formed, will be referred to as the surface. As shown in the diagram, the entire glass substrate 1 has an outline of portrait rectangular shape, conforming to a rectangular display panel that is stacked and arranged portrait below (on the bottom side). The four corners of the rectangular shape are continuously formed by quadrant arcs because of design needs as to the surface configuration of an apparatus on which the touch panel is mounted. The glass substrate 1′ may be made of various types of transparent glass such as borosilicate glass. In the present embodiment, soda glass is used.

A plurality of X detection electrode traces Xn and a plurality of Y detection electrode traces Yn are formed on the surface of the transparent glass substrate 1′ so as to intersect each other in orthogonal X and Y directions. The detection electrode traces Xn and Yn are made of a transparent conductive material such as indiumtin oxide (ITO) so that an underlying display panel is visible. The plurality of X detection electrode traces Xn are formed at equal pitches in the X direction. Each X detection electrode trace Xn is formed to repeat a rhombic shape continuously along the Y direction. The plurality of Y detection electrode traces Yn are formed at equal pitches in the Y direction. Each Y detection electrode trace Yn is formed to repeat a rhombic shape continuously along the X direction. The rhombuses of the X detection electrode traces Xn and the rhombuses of the Y detection electrode traces Yn are complementary to each other in outline. Orthogonally arranged, the plurality of X detection electrode traces Xn and the plurality of Y detection electrode traces Yn cover almost an entire input operation area EA of rectangular shape.

The X detection electrode traces Xn and the Y detection electrode traces Yn intersect at respective narrow portions at the rhombus corners. At the intersections, the X detection electrode traces Xn and the Y detection electrode traces Yn are vertically isolated and insulated from each other via intermediate insulation pieces 2 of small area. The intermediate insulation pieces 2, which are small and made of a transparent insulating material, are hardly noticeable.

The X detection electrode traces Xn and the Y detection electrode traces Yn are electrically connected to respective lead wiring traces 3 at boundaries of the input operation area EA. The wiring traces 3 lead the detection electrode patterns Xn and Yn to the lower left corner of FIG. 1, where the detection electrode traces Xn and Yn can be electrically connected to a detection circuit unit of the touch panel which detects an input position from a change in capacitance on certain detection electrode traces Xn and Yn. The detection electrode traces Xn and Yn are made of ITO which has a specific resistance higher than that of ordinary metals. The wiring traces 3 are then made of aluminum or silver which has a low specific resistance so that the combined resistance up to the output decreases for favorable detection sensitivity. Although aluminum or silver is relatively less noticeable, the formed wiring traces 3 are visible. The periphery of the input operation area EA, between the input operation area EA and the edges of the glass substrate 1, is then printed in black or other non-transparent ink for so-called black frame print. This forms a color decoration layer 6 around the input operation area EA, where the wiring traces 3 are formed so as not to be visible.

The detection electrode traces Xn and Yn and the wiring traces 3 formed on the surface of the glass substrate 1′ are entirely covered with an overcoat 4 which is made of a transparent insulating material. It should be noted that the glass substrate 1′ according to the present embodiment is chemically strengthened, and no microcracks will occur in the periphery in the manufacturing steps to be described later. The glass substrate 1′ therefore has predetermined strength even with a thickness of 1 mm or less, and it is not needed to overlay a transparent protective panel on the side of the input operation surface or apply a transparent protective film as heretofore.

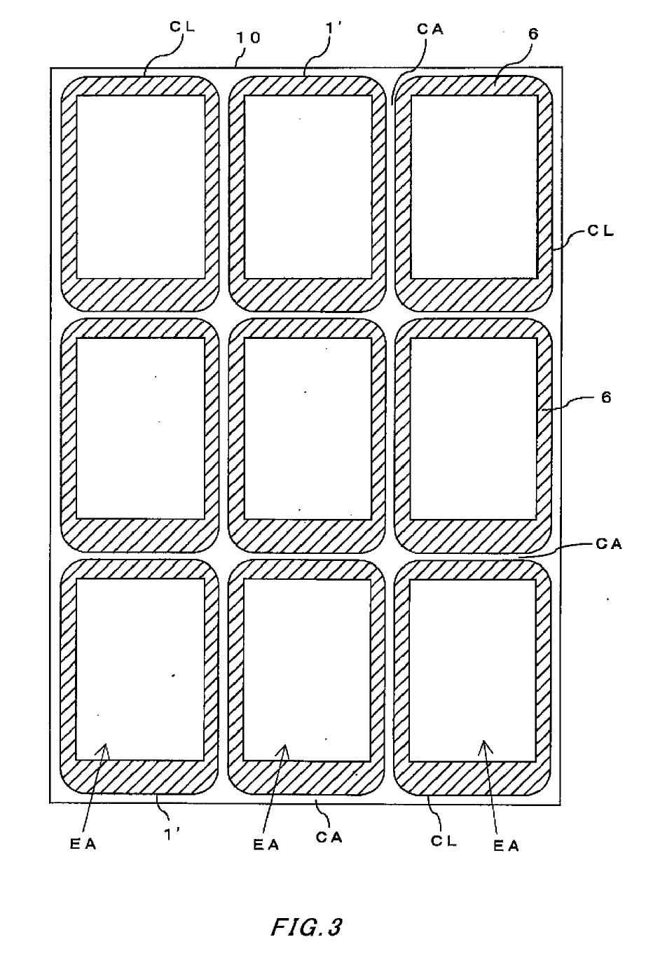

As shown in FIGS. 3 to 5, the glass substrate 1′ is cut out of an original glass plate 10 that is as large as to manufacture nine touch panel glass substrates 1. The steps of manufacturing the touch panel glass substrate 1 will be described below with reference to FIGS. 3 to 6.

An original glass plate 10 of rectangular shape is cut out of an even larger original plate of soda glass by scribing and cutting or other method. As shown in FIG. 3, the original glass plate 10 is cut out in a rectangular outline that circumscribes a whole of nine glass substrates 1′. Here, the nine glass substrates 1′ to be cut out are arranged in a matrix so as not to overlap each other, with cutting areas CA of at least several millimeters in width around respective cutting lines CL. The cutting lines CL are virtually-assumed projections of the outlines of the nine glass substrate 1′ upon the surface and underside of the original glass plate 10. On the original glass plate 10, each area surrounded by a cutting line CL of rectangular configuration with four corners connected by quadrants constitutes a glass substrate area to be a glass substrate 1′.

Initially, the original glass plate 10 is immersed into a molten salt of potassium nitrate heated to around 380° C., whereby the glass surface is chemically strengthened by ion exchange. The chemical strengthening strengthens the original glass plate 10 and the glass substrates 1′ separated from the original glass plates 10 about fivefold as compared to before the chemical strengthening.

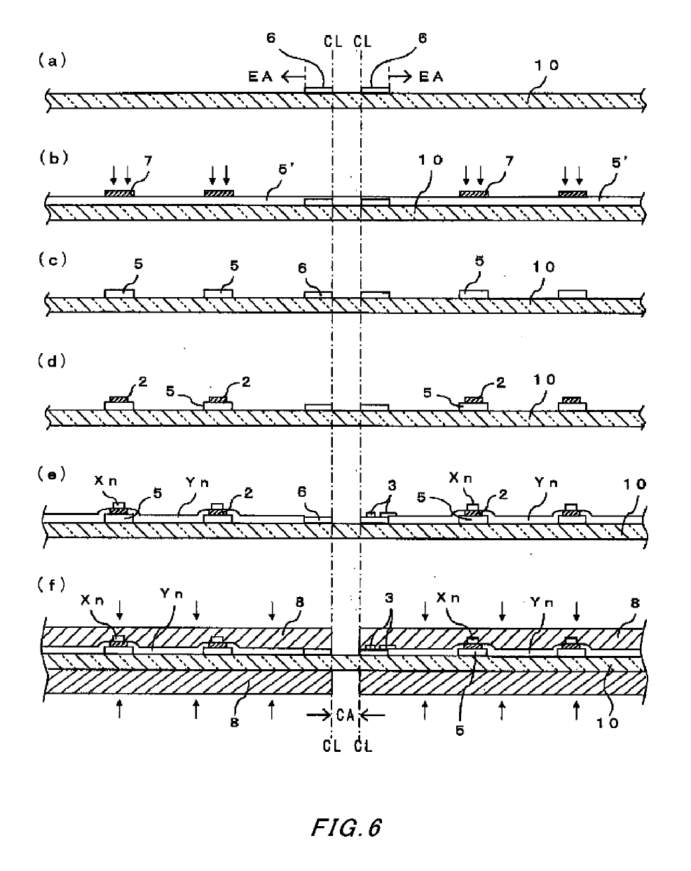

Subsequently, as shown in FIGS. 3 and 6(a), black frames are printed on the original glass plate 10 in black ink to form a color decoration layer 6 between the peripheries of the respective input operation areas EA and the assumed cutting lines CL.

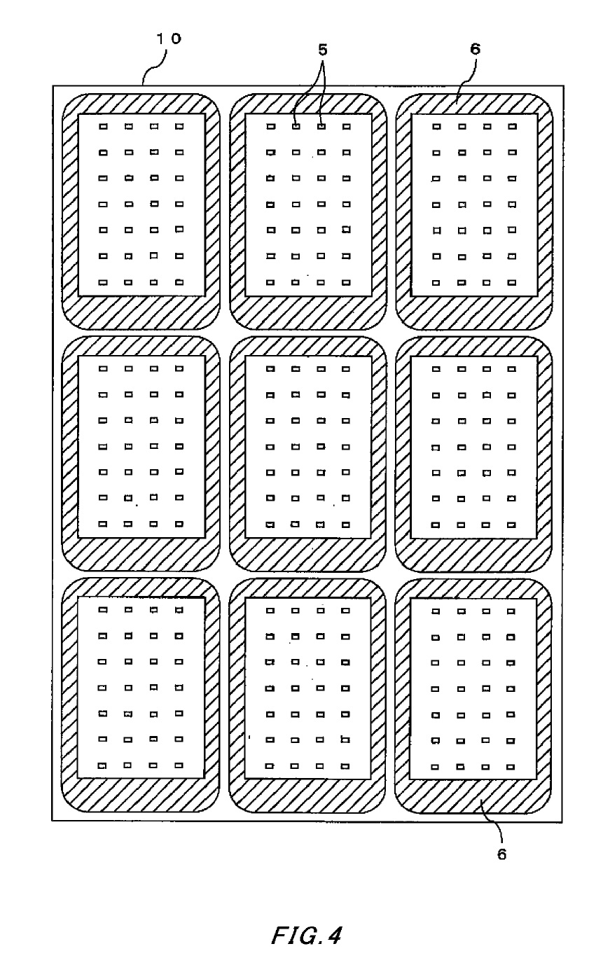

A transparent conductive film 5′ of ITO is then deposited by sputtering over the entire surface of the original glass plate 10 on which the color decoration layer 6 has been formed. The entire article is passed through a roll coater to apply a photoresist layer 7 onto the transparent conductive film 5′. As shown in FIG. 6(b), the photoresist layer 7 is exposed and developed in portions where to form connection conductor pieces 5. With the resulting photoresist layer 7 as a mask, the transparent conductive layer 5′ is etched so that the transparent conductive layer 5′ remains under the mask. As shown in FIGS. 4 and 6(c), the etching forms connection conductor pieces 5 of strip shape at the portions where the X detection electrode traces Xn and the Y detection electrode traces Yn intersect.

As shown in FIG. 6(d), intermediate insulation pieces 2 are formed across over the connection conductor pieces 5 by using a similar photolithographic technique, screen printing, or the like.

The X detection electrode traces Xn and the Y detection electrode traces Yn are then formed on the surfaces of the glass substrates 1′. The detection electrode traces Xn and Yn are formed by photolithographic patterning. A transparent conductive film of ITO is deposited by sputtering over the entire surfaces of the glass substrates 1′ on which the intermediate insulation pieces 2 and the connection conductor pieces 5 are formed. A photoresist layer is applied onto the entire surface. The photoresist layer is then exposed and developed in portions where to form the X detection electrode traces Xn and rhombic Y detection electrode traces Yn. With the resulting photoresist layer as a mask, the transparent conductive film is etched off to form the X detection electrode traces Xn and Y detection electrode traces Yn. As a result, the rhombic portions of the Y detection electrode traces Yn adjoining in the X direction are connected through the connection conductor pieces 5, whereby the Y detection electrode traces Yn are formed so as to extend in the X direction. The connections between the rhombic portions of the X detection electrode traces Xn are formed on the intermediate insulation pieces 2, whereby the X detection electrode traces Xn are insulated from the Y detection electrode traces Yn and formed so as to extend in the Y direction.

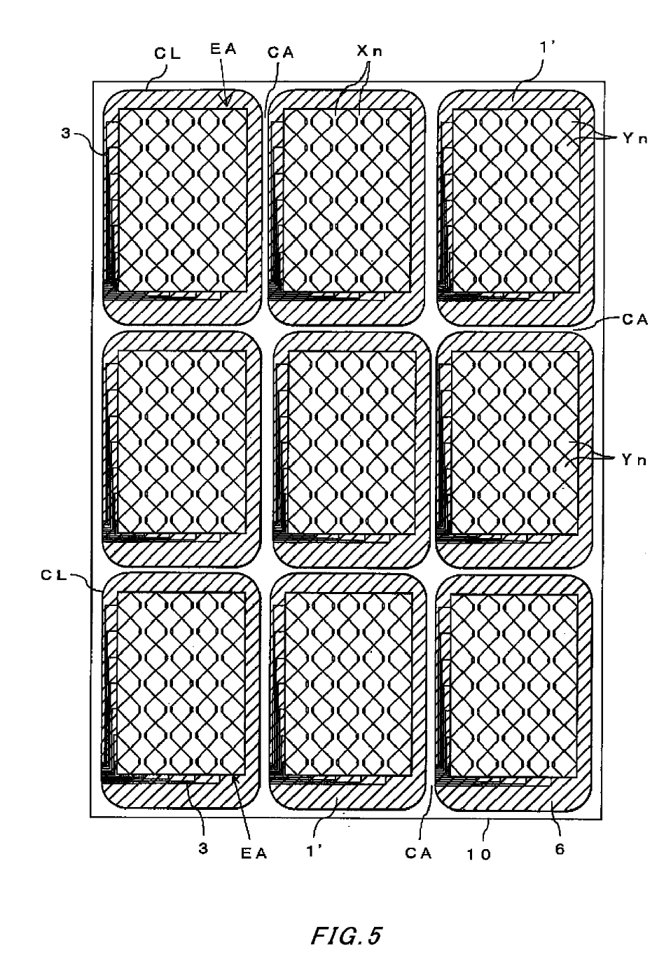

As shown in FIGS. 5 and 6(e), the X detection electrode traces Xn and the Y detection electrode traces Yn are connected to the respective wiring traces 3 of silver at the boundaries of the input operation areas EA. The wiring traces 3 are formed in the black frame-printed peripheries of the input operation areas EA by screen printing or by mask sputtering. For external circuit connection, the wiring traces 3 are lead out to the lower left of the respective glass substrates 1′ which are surrounded by the cutting lines CL.

The steps of forming a so-called sensor surface, from the chemical strengthening to the formation of the wiring traces 3, can be simultaneously performed for nine glass substrates 1′. This significantly shortens the mass production steps.

The nine glass substrates 1′ are separated from the original glass plate 10 by chemical etching. For that purpose, a photoresist film 8 having hydrofluoric acid resistance is applied to the entire surface and underside of the original glass plate 10. The photoresist film 8 is exposed and developed, except in the cutting areas CA which are defined by the cutting lines CL. The unexposed photoresist film is then removed from the cutting areas CA by using an alkali solution. Consequently, as shown in FIG. 6(f), the areas corresponding to the glass substrates 1′ are covered with the light-cured photoresist film 8 on both the surface and the underside.

Subsequently, the original glass plate 10 is immersed into a chemical polishing solution containing hydrofluoric acid. The cutting areas CA are chemically etched to separate the nine glass substrates 1′ from the original glass plate 10. During the chemical etching step, the sensor surfaces on which the detection electrode traces Xn and Yn are formed are covered with the photoresist film 8 and thus are prevented from chemical attack of the etching solution.

The photoresist film 8 adhering to the surface and underside of each glass substrate 1′ separated from the original glass plate 10 is removed by using an alkali solution. The glass substrate 1′ is then passed through a spin coater or the like so that an overcoat 4 of transparent insulating material is applied to the entire surface on which the detection electrode traces Xn and Yn have been formed. This completes the touch panel glass substrate 1.

The foregoing embodiment has dealt with a touch panel glass substrate 1 that is intended for a capacitive touch panel. However, the present invention is also applicable to a touch panel glass substrate that is intended for a touch panel of different input position detection method, where the sensor surface including the detection electrode traces has a different configuration and the sensor surface is formed by different manufacturing steps. For example, a resistive pressure-sensitive touch panel includes resistive pressure-sensitive X and Y detection electrode traces which are opposed to each other via an insulating gap. In such a case, two touch panel glass substrates manufactured according to the present invention may be stacked so that detection electrode traces made of resistive layers are opposed to each other via a spacer.

The sensor-surface manufacturing steps, by which detection electrode traces and lead wiring traces are formed on the surfaces of glass substrates, are not limited to the order described in the foregoing embodiment. The order of the manufacturing steps may vary depending on the configuration of the detection electrode traces as long as the cutting areas CA are chemically etched at least after the formation of the sensor surfaces.

The color decoration layer 6 may include outlined characters, and the wiring traces may be formed to cover the area of the outlined characters. This allows the color of the wiring traces to pass through the outlined characters to provide a character display that is visible from the front side of the touch panel glass substrate. In particular, the color decoration layer 6 can be formed in black or similar color tones to increase the contrast to the color of the wiring traces (aluminum or silver). This makes the outlined character display clearer.

The original glass plate 10 need not necessarily be chemically strengthened if the original glass plate 10 is thick enough to provide required strength without chemical strengthening.

The black frame printing step is not always needed. A touch panel glass substrate 1 manufactured according to the present invention may be covered with a decoration film equivalent to black frame print.

The formation of a photoresist layer or photoresist film in the foregoing steps may be replaced by application of a film resist.

The present invention is suitable for a touch panel glass substrate that needs low-profile configuration and strength, and a method for manufacturing the same.

What is claimed is:

1. A method for manufacturing a touch panel glass substrate, the touch panel including a glass substrate on a surface of which a plurality of detection electrode traces made of a transparent conductive layer and a plurality of lead wiring traces electrically connected to the respective detection electrode traces are formed, the method comprising:
a step 1 of virtually assuming cutting lines on both a surface and an underside of an original glass plate as large as to separate a plurality of glass substrates from, and forming a plurality of detection electrode traces made of a transparent conductive layer by patterning in each of glass substrate areas surrounded by the cutting lines on the surface of the original glass plate, the cutting lines being projections of outlines of the plurality of glass substrates on the surface and the underside;
a step 2 of forming lead wiring traces in each of the glass substrate areas, the lead wiring traces being electrically connected to the respective detection electrode traces;
a step 3 of forming a resist film on both the surface and the underside of the original glass plate on which the plurality of detection electrode traces and lead wiring traces have been formed in the steps 1 and 2, except in cutting areas along the cutting lines; and
a step 4 of chemically etching the cutting areas on both the surface and the underside of the original glass plate with the resist film as a mask, thereby separating each glass substrate from the original glass plate.

2. The method for manufacturing a touch panel glass substrate according to claim 1, wherein the plurality of detection electrode traces and lead wiring traces are formed in the steps 1 and 2 on each of the glass substrate areas of an original glass plate that has been chemically strengthened.

3. The method for manufacturing a touch panel glass substrate according to claim 1, wherein a color decoration layer is formed on each of the glass substrate areas of the original glass plate before the plurality of detection electrode traces are formed in the step 1.

4. The method for manufacturing a touch panel glass substrate according to claim 3, wherein the color decoration layer includes an outlined character, and the lead wiring traces are formed to cover the outlined character.

5. A touch panel glass substrate manufactured by the manufacturing method according to claim 1.

6. The touch panel glass substrate according to claim 5, wherein the cutting lines include a curve at least in part.
